(19) United States
(12) Patent Application Publication
(10) Pub. No.: US 2023/0298292 A1
(43) Pub. Date: Sep. 21, 2023

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Hirotake SASAKI, Kanagawa (JP); Kiyoshi IIDA, Kanagawa (JP); Takashi MORIKAWA, Kanagawa (JP); Toshihiko SUZUKI, Kanagawa (JP)

(73) Assignee: FUJIFILM Business Innovation Corp., Tokyo (JP)

(21) Appl. No.: 17/901,411

(22) Filed: Sep. 1, 2022

(30) Foreign Application Priority Data
Jan. 31, 2022 (JP) 2022-013591

(51) Int. Cl. G06T 19/20; G06T 15/10

(52) U.S. Cl. CPC G06T 19/20; G06T 15/10; G06T 2219/004; G06T 2219/2008

(57) ABSTRACT

An information processing apparatus includes a processor configured to: generate a virtual reality space, an augmented reality space, or a mixed reality space; place multiple drawing surfaces in the generated space; and display a surface indicator to make a drawing surface recognizable without obscuring information recorded on another drawing surface, the drawing surface being selected as a target for drawing from the multiple drawing surfaces.

### CROSS-REFERENCE TO RELATED APPLICATIONS

This application is based on and claims priority under 35 USC 119 from Japanese Patent Application No. 2022-013591 filed Jan. 31, 2022.

### BACKGROUND

### (I) Technical Field

The present disclosure relates to an information processing apparatus, a non-transitory computer readable medium storing a program, and an information processing method.

### (II) Related Art

Japanese Unexamined Patent Application Publication No. 2006-154900 has proposed an image presentation system including an image input unit, a handwriting extractor, a relative coordinate detector, an image recorder, and a handwriting-image presentation device. The image input unit is configured to receive a drawing image that captures a motion of writing by hand on a virtual surface, the handwriting extractor is configured to acquire a handwriting image by extracting a handwriting trace from the drawing image by image processing, the relative coordinate detector is configured to detect the relative coordinates with regard to the position where the handwriting image is located, the image recorder configured to record the handwriting image together with the relative coordinates, and the handwriting-image presentation device includes an image display and a combiner, the image display being configured to present the handwriting image, the combiner being configured to reflect light from the image display and pass light from user’s actual view in the line of sight direction. The image presentation system is configured to pass light through the combiner to superimpose on the actual image a virtual image of the handwriting image presented by the image display and present the virtual image and the actual image.

Japanese Unexamined Patent Application Publication No. 2013-003961 has proposed an electronic pen in a spatial handwriting system including the electronic pen and a display device that are communicatively connected with each other. The electronic pen in the spatial handwriting system includes a coordinate detector, a virtual plane creator, a stroke detector, a coordinate converter, and a communication unit. The coordinate detector is configured to detect the coordinates of the tip of the pen in the three-dimensional space, the virtual plane creator is configured to create a virtual plane based on points arranged in the space, the stroke detector is configured to detect the movement of the tip of the pen in the direction normal to the virtual plane in response to the variation in the coordinates in the three-dimensional space and recognize a gap in a stroke when the amount of movement, the velocity of movement, or the acceleration of movement of the tip of the pen in the normal direction exceeds a predetermined threshold, the coordinate converter is configured to convert coordinates in the three-dimensional space representing a continuous trace of the stroke of the tip of the pen between a gap and a next gap of the stroke into planar coordinates on the virtual plane with a specific point on the plane designated as the origin, and a communication unit is configured to output to an external device the information with regard to the planar coordinates obtained by the conversion.

Japanese Unexamined Patent Application Publication No. 2016-110249 has proposed a spatial handwriting input system including a coordinate detector, a virtual-plane setting unit, a coordinate converter, an input trace acquiring unit, a degree-of-contact acquiring unit, and a display. The coordinate detector is configured to detect three-dimensional coordinates of a trace of pointer movement, the virtual-plane setting unit is configured to place a virtual plane in the three-dimensional space, the coordinate converter is configured to convert the three-dimensional coordinates of the trace of pointer movement, the input trace acquiring unit is configured to acquire a trace in the XY plane of the trace of pointer movement as an input trace, the degree-of-contact acquiring unit is configured to calculate and acquire a degree of contact with respect to the virtual plane by using the position of the trace of pointer movement in the Z-axis direction, and the display is configured to present the input trace on a graphical user interface (GUI) screen when the degree of contact exceeds a threshold and present on the GUI screen an indicator for presenting the position of the pointer and the distance to the virtual plane. The display in the spatial handwriting input system is configured to change the way in which to present the trace for display in accordance with the degree of contact.

### SUMMARY

Placing multiple drawing surfaces is anticipated in a system for performing drawing in a virtual reality space, an augmented reality space, or a mixed reality space. However, when multiple drawing surfaces are placed in a virtual reality space, an augmented reality space, or a mixed reality space, it is difficult to unmistakably indicate a surface selected as a target for drawing without obscuring information recorded on a surface other than the surface selected as a target for drawing.

Aspects of non-limiting embodiments of the present disclosure relate to providing an information processing apparatus, a non-transitory computer readable medium storing an information processing program, and an information processing method that can place multiple drawing surfaces in a virtual reality space, an augmented reality space, or a mixed reality space and that can unmistakably indicate a surface selected as a target for drawing without obscuring information recorded on a surface other than the surface selected as a target for drawing.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: generate a virtual reality space, an augmented reality space, or a mixed reality space; place a plurality of drawing surfaces in the generated space; and display a surface indicator to make a drawing surface recognizable without obscuring information recorded on another drawing surface, the drawing surface being selected as a target for drawing from the plurality of drawing surfaces.

### BRIEF DESCRIPTION OF THE DRAWINGS

An exemplary embodiment of the present disclosure will be described in detail based on the following figures, wherein:

FIG. 1 is an illustration depicting a schematic configuration of an information processing system according to the present exemplary embodiment;

FIG. 2 is a block diagram depicting a configuration of major electrical components of a virtual reality (VR) device in the information processing system according to the present exemplary embodiment;

FIG. 3 is a block diagram depicting an example of a functional configuration of the VR device in the information processing system according to the present exemplary embodiment;

FIG. 4 is an illustration depicting a real space and a virtual reality space;

FIG. 5 is an illustration depicting an example of displaying a frame on a drawing surface as a surface indicator;

FIG. 6 is a flowchart depicting an example of a process performed by the VR device in the information processing system according to the present exemplary embodiment;

FIG. 7 is an illustration depicting correspondences between characters written on three drawing surfaces;

FIG. 8 is an illustration depicting positional relationships between images drawn on two drawing surfaces;

FIG. 9 is an illustration depicting an example of drawing surfaces placed in multiple directions to surround a user;

FIG. 10 is an illustration depicting an example of drawing surfaces surrounding a three-dimensional computer-aided design (CAD) model;

FIG. 11 is an illustration depicting an example of drawing surfaces entering a three-dimensional CAD model;

FIG. 12 is an illustration depicting an example of drawing surfaces spherically surrounding a user;

FIG. 13 is a flowchart depicting a modification to the process performed by the VR device in the information processing system according to the present exemplary embodiment; and

FIG. 14 is a flowchart depicting an example of a process of changing a drawing-surface setting.

### DETAILED DESCRIPTION

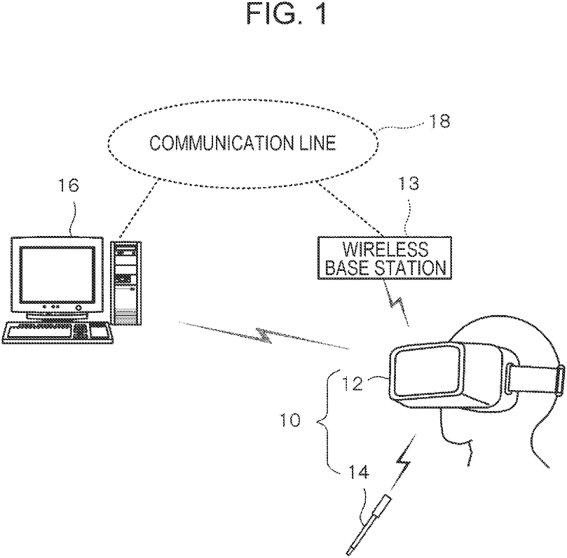

Hereinafter, an example according to the present exemplary embodiment will be described in detail with reference to the drawings. In the present exemplary embodiment, description will be given as an example with regard to an information processing system configured to perform drawing in a virtual reality (VR) space. FIG. 1 is an illustration depicting a schematic configuration of an information processing system 10 according to the present exemplary embodiment. A virtual reality technology is a technology that enables a user to experience a virtual world generated by a computer as if it were real.

As depicted in FIG. 1, the information processing system 10 according to the present exemplary embodiment includes a VR device 12, which is an information processing apparatus capable of displaying an image in a virtual reality space by using a device such as a head mounted display (HMD), and an input device 14 configured to perform drawing in the virtual reality space. The VR device 12 and the input device 14 can wirelessly communicate with each other and exchange information via wireless communication. For example, Wi-Fi (registered trademark), Wi-Fi DIRECT (registered trademark), Bluetooth (registered trademark), and other technologies may be used for wireless communication between the VR device 12 and the input device 14. The VR device 12 and the input device 14 need not be connected wirelessly, may be connected by wireline, and communicate with each other via wireline communication.

In the present exemplary embodiment, the VR device 12 is configured to generate a virtual reality space, receive information from the input device 14, and display an image drawn in the virtual reality space. For example, as depicted in FIG. 1, the input device 14 of a pen type is used, and moving the input device 14 of a pen type in the virtual reality space produces a trace of movement in the virtual reality space generated by the VR device 12. The trace of movement is displayed as an image in the virtual reality space generated by the VR device 12, thereby performing drawing in the virtual reality space.

As represented by a dotted line in FIG. 1, an information-processing terminal apparatus 16 connected to a communication line 18 such as a network may be connected to the VR device 12 by using a wireless base station 13, and the information-processing terminal apparatus 16 may generate a virtual reality space and perform control of drawing in the virtual reality space. Examples of the information-processing terminal apparatus 16 include a client computer and a server. Alternatively, the information-processing terminal apparatus 16 and the VR device 12 may directly be connected by using wireless or wireline communication, and the information-processing terminal apparatus 16 may generate a virtual reality space and perform control of drawing in the virtual reality space.

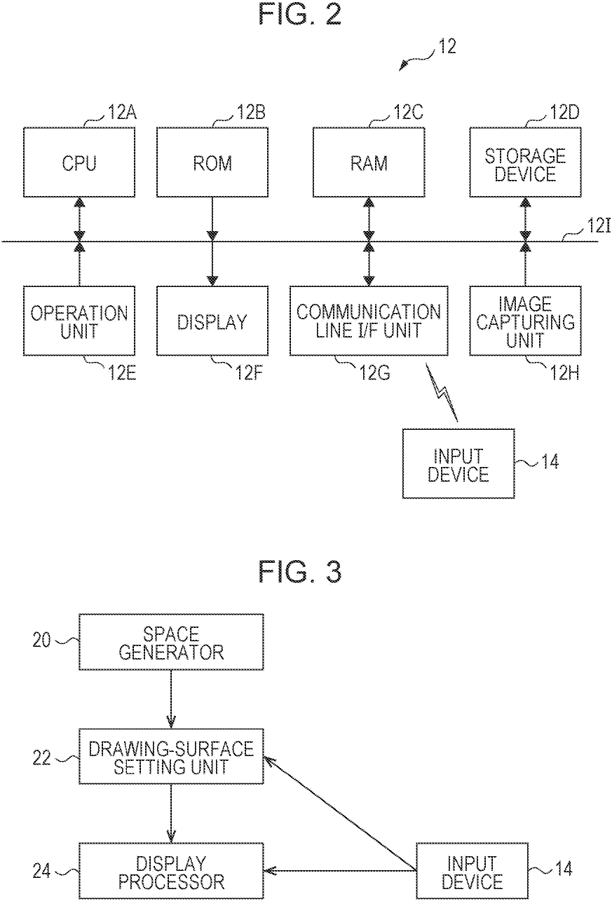

FIG. 2 is a block diagram depicting a configuration of major electrical components of the VR device 12 in the information processing system 10 according to the present exemplary embodiment.

As depicted in FIG. 2, the VR device 12 according to the present exemplary embodiment includes a central processing unit (CPU) 12A as an example of a processor, a read only memory (ROM) 12B, a random access memory (RAM) 12C, a storage device 12D, an operation unit 12E, a display 12F, a communication line interface (I/F) unit 12G, and an image capturing unit 12H. The CPU 12A is configured to manage overall operation of the VR device 12. The ROM 12B is configured to store various control programs, various parameters, and other data in advance. The RAM 12C is used as a work area and the like while the CPU 12A executes various programs. The storage device 12D is configured to store various kinds of data, application programs, and other data. The operation unit 12E is used for entering various kinds of information. The display 12F is used for displaying various kinds of information. The image capturing unit 12H is configured to output image information acquired by capturing an image. The communication line I/F unit 12G is connected to the communication line 18, and the VR device 12 causes the CPU 12A to control transmission and reception of communication data via the communication line I/F unit 12G. All the above components in the VR device 12 are electrically connected to each other by using a system bus 12I.

The information-processing terminal apparatus 16 basically has a configuration of a general-purpose computer including a CPU, a ROM, and a RAM, and the configuration is similar to the VR device 12 except the image capturing unit 12H in FIG. 2. Thus, detailed description will be omitted. Similarly, the input device 14 also basically has a configuration similar to the configuration of the VR device 12, and detailed description will be omitted.

In the information processing system 10 according to the present exemplary embodiment, the CPU 12A of the VR device 12 loads a program stored in the storage device 12D into the RAM 12C and executes the program, thereby functioning as each unit depicted in FIG. 3.

FIG. 3 is a block diagram depicting an example of a functional configuration of the VR device 12 in the information processing system 10 according to the present exemplary embodiment.

As depicted in FIG. 3, the CPU 12A of the VR device 12 in the information processing system 10 according to the present exemplary embodiment includes functions of a space generator 20, a drawing-surface setting unit 22, and a display processor 24.

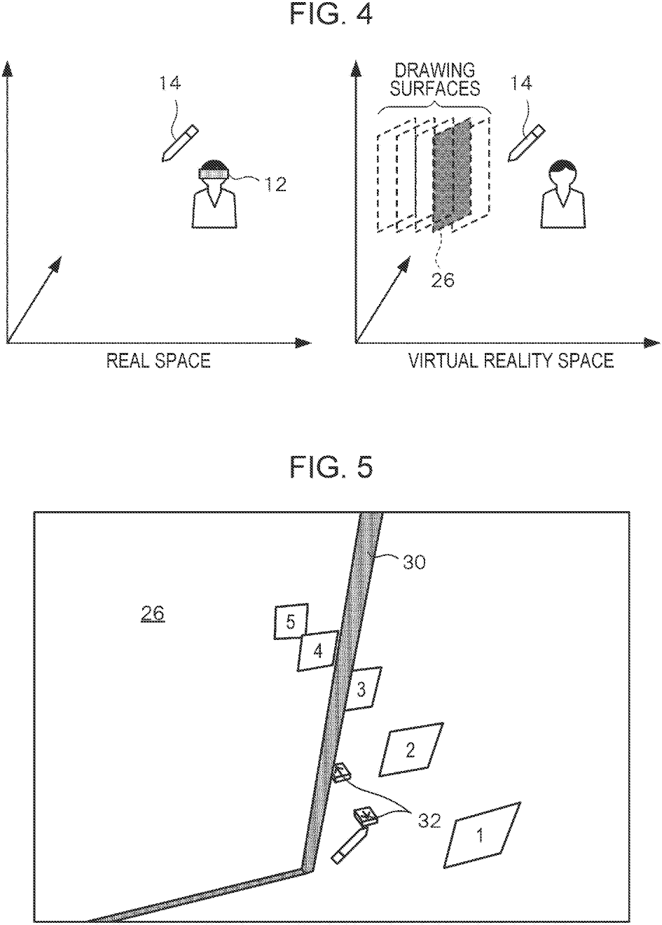

As depicted in FIG. 4, the space generator 20 is configured to generate a virtual reality space through computing. The virtual reality space is a space in which drawing is allowed in three dimensions, which differs from the real space in which a user is present together with the VR device 12 and the input device 14.

As depicted in FIG. 4, the drawing-surface setting unit 22 is configured to place a drawing surface 26 in the virtual reality space generated by the space generator 20. Drawing by using the input device 14 is allowed on the drawing surface 26. Multiple drawing surfaces 26 can be placed. For example, a predetermined number of drawing surfaces 26 may be placed, or a user-defined number of drawing surfaces 26 may be placed. Alternatively, a drawing surface 26 is placed, and another drawing surface 26 may be added one by one in accordance with the user’s instruction. A drawing surface 26 has a predetermined size, such as 20 m × 10 m, and if multiple drawing surfaces 26 are placed, the multiple drawing surfaces 26 are placed at predetermined intervals (for example, 20 cm intervals) along the user’s line of sight in a direction substantially perpendicular to the multiple drawing surfaces 26.

The display processor 24 is configured to acquire information from the input device 14 and display a trace of movement of the input device 14 on the drawing surface 26 as an image. The display processor 24 is configured to display a surface indicator to make a drawing surface 26 selected as a target for drawing recognizable without obscuring information recorded on other drawing surfaces 26 if multiple drawing surfaces 26 are placed in the virtual reality space. For example, a surface indicator is displayed to make the drawing surface 26 selected as a target for drawing distinguishable from other drawing surfaces 26. Specifically, a translucent color or a predetermined pattern, such as a grid pattern, is added to the drawing surface 26 selected as a target for drawing as depicted in FIG. 4, or a frame 30 is added to the drawing surface 26 selected as a target for drawing as depicted in FIG. 5. In this way, a surface indicator is generated and displayed.

The display processor 24 is configured to display in the virtual reality space a control tool such as a button for selecting another drawing surface 26 as a target for drawing if multiple drawing surfaces 26 are placed. In response to an operation such as an operation on the button to select another drawing surface 26 by using the input device 14, the display processor 24 selects the other drawing surface 26 on which to display a surface indicator. As depicted in FIG. 5 as an example, an indicator such as a number for identifying a drawing surface 26 generated in the virtual reality space is displayed, for example, in a lower portion of the space, and two arrow buttons 32 are displayed to select a drawing surface 26. An operation on one of the arrow buttons 32 by using the input device 14 of a pen type moves the surface indicator, thereby selecting another drawing surface 26 as a target for drawing. Alternatively, an operation on the number corresponding to a drawing surface 26 selects the drawing surface 26 as a target for drawing and displays the surface indicator on the drawing surface 26.

Various known techniques are used to draw on a drawing surface 26 by using the input device 14. For example, a mechanical button added to the input device 14 of a pen type enables a user to draw by moving the input device 14 while the mechanical button is being pushed. The VR device 12 causes a unit such as the image capturing unit 12H to capture an image of the input device 14 to detect a trace of the tip of the input device 14 while the mechanical button is being pushed, or the VR device 12 detects, for example, the acceleration or the attitude of the input device 14 to detect a trace of the input device 14 of a pen type. Then, drawing is performed on the drawing surface 26 by displaying the detected trace on the drawing surface 26.

In addition, an operation on the input device 14 may translate a drawing surface 26 up and down and left and right to move the position of the drawing. An operation such as an operation on a button may select another drawing surface 26 placed adjacent to the drawing surface 26 currently selected as a target for drawing. The positional relationship between the drawing surfaces 26 is maintained during such an operation.

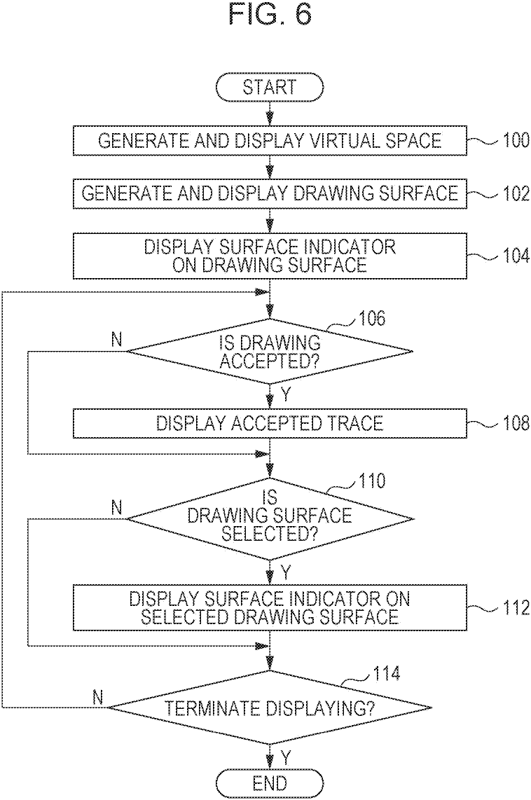

Next, description will be given with regard to a process performed by the VR device 12 in the information processing system 10 according to the present exemplary embodiment, the information processing system 10 being configured as described above. FIG. 6 is a flowchart depicting an example of the process performed by the VR device 12 in the information processing system 10 according to the present exemplary embodiment. The process in FIG. 6 starts, for example, when a power supply (not depicted) of the VR device 12 is turned on.

In step 100, the CPU 12A generates a virtual space in which drawing is allowed in three dimensions and causes the display 12F to display the virtual space, and the process proceeds to step 102. Specifically, as depicted in FIG. 4, the space generator 20 generates a virtual reality space through computing. The virtual reality space is a space in which drawing is allowed in three dimensions, which differs from the real space in which a user is present together with the VR device 12 and the input device 14.

In step 102, the CPU 12A generates a drawing surface 26 and causes the display 12F to display the drawing surface 26, and the process proceeds to step 104. Specifically, the drawing-surface setting unit 22 places a drawing surface 26 on which drawing by using the input device 14 is allowed in the virtual reality space generated by the space generator 20.

In step 104, the CPU 12A displays a surface indicator on the drawing surface 26, and the process proceeds to step 106. For example, the display processor 24 adds a translucent color or a predetermined pattern, such as a grid pattern, to the drawing surface 26 selected as a target for drawing as depicted in FIG. 4 or adds the frame 30 to the drawing surface 26 selected as a target for drawing as depicted in FIG. 5. In this way, the display processor 24 generates and displays a surface indicator.

In step 106, the CPU 12A determines whether drawing is accepted. For example, it is determined in step 106 whether the input device 14 is operated to perform drawing. If an affirmative determination is made in step 106, the process proceeds to step 108. If a negative determination is made in step 106, the process proceeds to step 110.

In step 108, the CPU 12A causes the display 12F to display the accepted trace, and the process proceeds to step 110. In other words, information recorded by the operation on the input device 14 is displayed by the display 12F. In this way, an image drawn on the drawing surface 26 in the virtual reality space is displayed by the display 12F. A piece of information recorded on the drawing surface 26 currently selected as a target for drawing and a piece of information recorded on another drawing surface 26 may be displayed differently from each other. For example, two pieces of information may be displayed by using different colors, different line widths, or different display densities. Alternatively, one piece of information may be caused to blink.

In step 110, the CPU 12A determines whether a drawing surface 26 is selected. It is determined in step 110 whether an operation of selecting a drawing surface 26 is performed. For example, it may be determined whether at least one of the arrow buttons 32 is operated to select a drawing surface 26, or it may be determined whether a switching operation is performed, for example, on a button attached to the input device 14 to switch between drawing surfaces 26. Alternatively, for example, based on a result of image capturing obtained by the image capturing unit 12H, it may be determined whether the user’s movement in the real space is detected. If an affirmative determination is made in step 110, the process proceeds to step 112. If a negative determination is made in step 110, the process proceeds to step 114.

In step 112, the CPU 12A displays the surface indicator on the selected drawing surface 26, and the process proceeds to step 114. Specifically, when another drawing surface 26 is selected, the surface indicator displayed on the current drawing surface 26 is moved to and displayed on the other drawing surface 26. In this way, if another drawing surface 26 is selected, the drawing surface 26 selected as a target for drawing is recognizable because of the surface indicator.

In step 114, the CPU 12A determines whether to terminate displaying. It is determined in step 114, for example, whether an operation is performed to turn off a power supply (not depicted). If a negative determination is made in step 114, the process returns to step 106 and repeats the above procedures. If an affirmative determination is made in step 114, a series of procedures ends.

Description will be given below with regard to anticipated situations in which placing multiple drawing surfaces 26 and visualizing information recorded on the drawing surfaces 26 are valued. In such situations, information is visualized on the drawing surface 26 selected as a target for drawing as well as on adjacent drawing surfaces 26, as in the information processing system 10 according to the present exemplary embodiment.

For example, a position of textual or graphical information located on a real-life whiteboard or a two-dimensional display provides a meaning only in two-dimensions, but a meaning can further be added with respect to a position of information in the depth direction by the information processing system 10 according to the present exemplary embodiment.

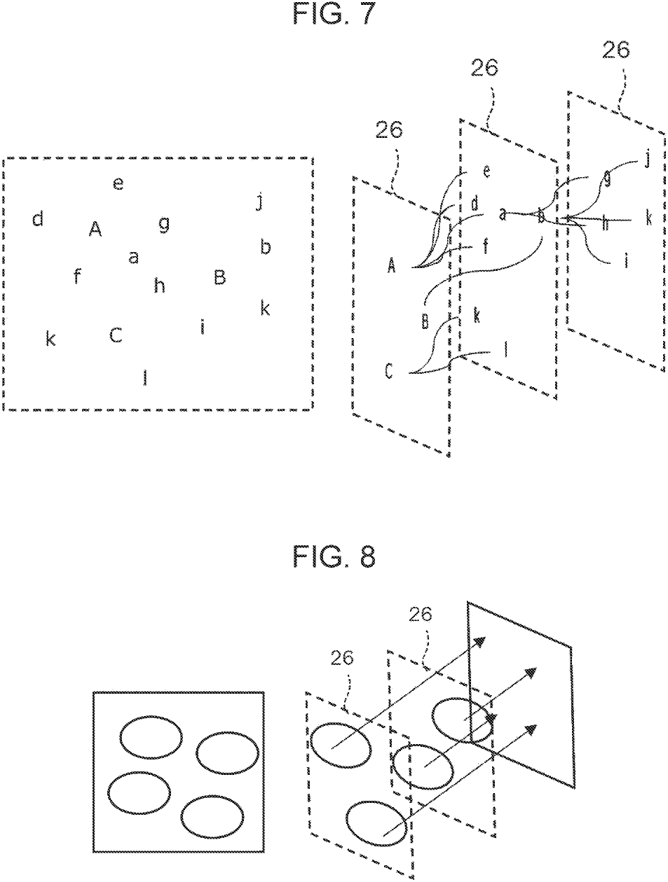

Further, when a drawing is added to an illustration displayed by a two-dimensional display, different layers can be used to express categorized information, but an operation such as switching between presenting and hiding a layer is necessary to make the categorized information recognizable. Different layers cannot be used to express categorized information printed on a sheet of paper in real life. In contrast, a position in the depth direction makes categorized information recognizable by using the information processing system 10 according to the present exemplary embodiment. For example, correspondence between characters written on three drawing surfaces 26 is recognizable as depicted in FIG. 7, and a positional relationship between images drawn on two drawing surfaces 26 is recognizable as depicted in FIG. 8.

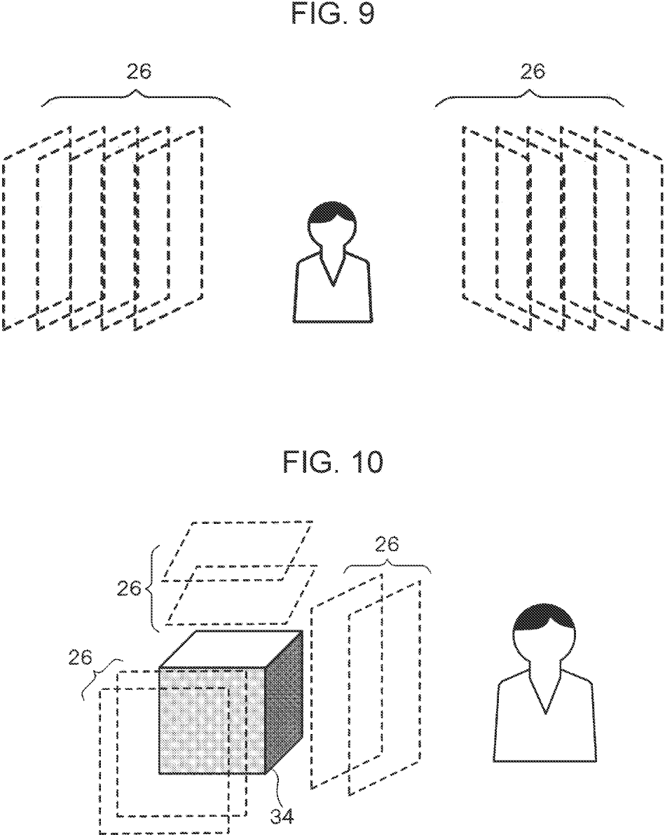

Multiple drawing surfaces 26 need not be generated in one direction and may be placed in multiple depth directions to surround the user as depicted in FIG. 9 as an example (in two directions in FIG. 9). Alternatively, multiple drawing surfaces 26 may surround a predetermined three-dimensional computer aided design (CAD) model 34 as a three-dimensional object as depicted in FIG. 10. Alternatively, multiple drawing surfaces 26 may enter the three-dimensional CAD model 34 as depicted in FIG. 11.

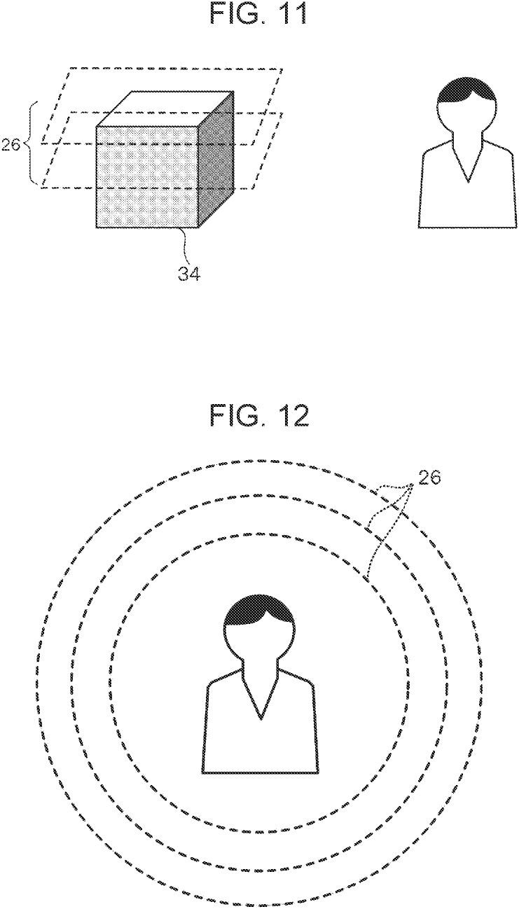

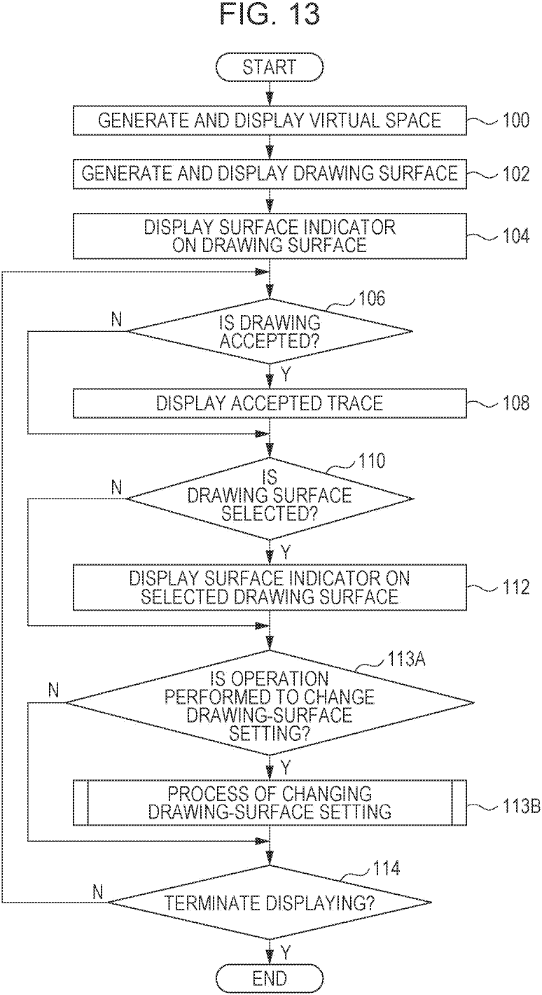

Further, a drawing surface 26 need not be planar and may be curved. As depicted in FIG. 12, drawing surfaces 26 may be spherically shaped and surround the user.

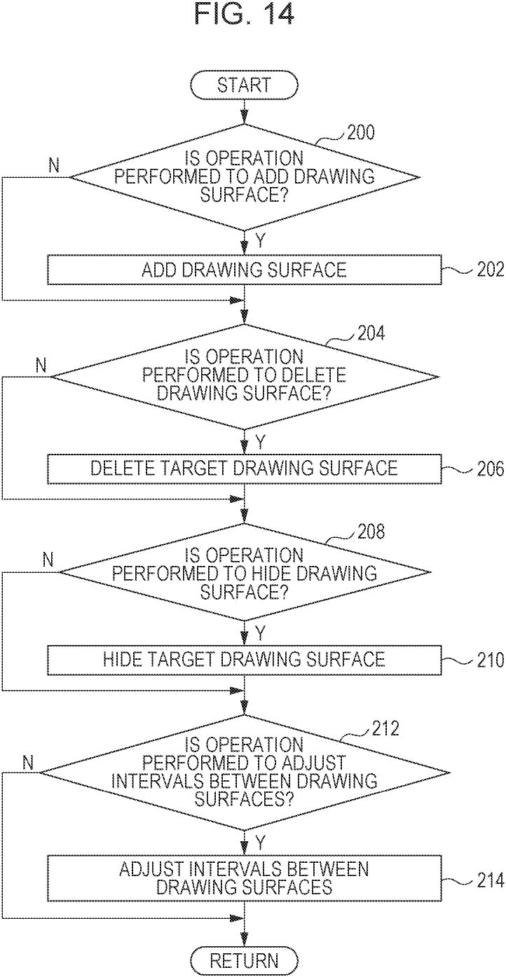

The process in FIG. 6 performed by the VR device 12 according to the above exemplary embodiment may additionally include procedures of steps 113A and 113B as depicted in FIG. 13. FIG. 13 is a flowchart depicting a modification to the process performed by the VR device 12 in the information processing system 10 according to the present exemplary embodiment. In FIG. 13, for description, the same symbols are attached to procedures that are the same as or similar to the procedures in FIG. 6.

Specifically, after a negative determination in step 110 or after the procedure in step 112, the process proceeds to step 113A.

In step 113A, the CPU 12A determines whether an operation is performed to change a drawing-surface setting. In step 113A, for example, it is determined whether an operation is performed by using the input device 14 to change a predetermined setting on a drawing surface 26. If an affirmative determination is made in step 113A, the process proceeds to step 113B. If a negative determination is made in step 113A, the process proceeds to step 114.

In step 113B, the CPU 12A performs a process of changing a drawing-surface setting, and the process proceeds to step 114.

The process of changing a drawing-surface setting will be described in detail herein with reference to FIG. 14. FIG. 14 is a flowchart depicting an example of the process of changing a drawing-surface setting.

In step 200, the CPU 12A determines whether an operation is performed to add a drawing surface 26. In step 200, for example, it is determined whether an operation to add a drawing surface 26 is performed on a component such as a switch attached to the input device 14 or a button displayed by the display 12F. If an affirmative determination is made in step 200, the process proceeds to step 202. If a negative determination is made in step 200, the process proceeds to step 204.

In step 202, the CPU 12A adds a drawing surface 26, and the process proceeds to step 204. A surface indicator may be displayed on the added drawing surface 26 at this time, indicating that the drawing surface 26 is selected as a target for drawing. Alternatively, a presentation may be displayed to inquire whether to select the added drawing surface 26 as a target for drawing, and the user may be allowed to make the selection.

In step 204, the CPU 12A determines whether an operation is performed to delete a drawing surface 26. In step 204, for example, it is determined whether an operation to delete a drawing surface 26 is performed on a component such as a switch attached to the input device 14 or a button displayed by the display 12F. If an affirmative determination is made in step 204, the process proceeds to step 206. If a negative determination is made in step 204, the process proceeds to step 208.

In step 206, the CPU 12A deletes the target drawing surface 26, and the process proceeds to step 208. Specifically, of the drawing surfaces 26 displayed by the display 12F, the CPU 12A deletes a drawing surface 26 that the CPU 12A is instructed to delete.

In step 208, the CPU 12A determines whether an operation is performed to hide a drawing surface 26. In step 208, for example, it is determined whether an operation to hide a drawing surface 26 is performed on a component such as a switch attached to the input device 14 or a button displayed by the display 12F. If an affirmative determination is made in step 208, the process proceeds to step 210. If a negative determination is made in step 208, the process proceeds to step 212.

In step 210, the CPU 12A hides the target drawing surface 26, and the process proceeds to step 212. Specifically, of the drawing surfaces 26 displayed by the display 12F, the CPU 12A hides a drawing surface 26 that the CPU 12A is instructed to hide.

In step 212, the CPU 12A determines whether an operation is performed to adjust intervals between drawing surfaces 26. In step 212, for example, it is determined whether an adjusting operation to adjust intervals between drawing surfaces 26 is performed on a component such as a switch attached to the input device 14 or a button displayed by the display 12F. If an affirmative determination is made in step 212, the process proceeds to step 214. If a negative determination is made in step 212, a series of procedures in the process of changing a drawing-surface setting is complete, and the process returns to step 114.

In step 214, the CPU 12A adjusts intervals between the drawing surfaces 26 and completes a series of procedures in the process of changing a drawing surface, and the process returns to step 114. Specifically, the CPU 12A adjusts intervals between the drawing surfaces 26 displayed by the display 12F to the prescribed intervals. Examples of a method of adjusting intervals include a drag operation to move a drawing surface 26.

Steps 200 to 214 may partially be performed as the process of changing a drawing-surface setting in FIG. 14. Specifically, at least one of the following processes may be performed as the process of changing a drawing-surface setting: a process of adding a drawing surface 26 in steps 200 to 202, a process of deleting a drawing surface 26 in steps 204 to 206, a process of hiding a drawing surface 26 in steps 208 to 210, and a process of adjusting intervals between drawing surfaces 26 in steps 212 to 214.

In the exemplary embodiment described above, the description has been given with regard to an example in which multiple drawing surfaces 26 are placed in the virtual reality space, but a space other than the virtual reality space may be adopted. For example, an augmented reality space or a mixed reality space may be adopted. An augmented reality technology is a technology to display a virtual world superimposed onto the real world, and a mixed reality technology is a technology to combine the real world and a sense of reality artificially created by a computer and produce a mixed sense of space.

In the embodiments above, a CPU has been described as an example of a processor, and the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The process performed by the information processing system 10 according to the exemplary embodiment above may be a process performed by using software, a process performed by using hardware, or a process performed by using a combination of software and hardware. The process performed by the information processing system 10 may be stored in a recording medium as a program and distributed by using the recording medium.

The present disclosure is not limited to the above exemplary embodiment, and various modifications to the above exemplary embodiment may obviously be practiced as long as they do not depart from the spirit of the disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
generate a virtual reality space, an augmented reality space, or a mixed reality space;
place a plurality of drawing surfaces in the generated space; and
display a surface indicator to make a drawing surface recognizable without obscuring information recorded on another drawing surface, the drawing surface being selected as a target for drawing from the plurality of drawing surfaces.

2. The information processing apparatus according to claim 1,
wherein the surface indicator is at least one selected from the group consisting of a translucent color, a grid pattern, and a frame.

3. The information processing apparatus according to claim 1,
wherein the plurality of drawing surfaces are placed in a direction substantially perpendicular to the plurality of drawing surfaces.

4. The information processing apparatus according to claim 2,
wherein the plurality of drawing surfaces are placed in a direction substantially perpendicular to the plurality of drawing surfaces.

5. The information processing apparatus according to claim 3,
wherein the plurality of drawing surfaces are placed in a plurality of directions, each of the plurality of directions being substantially perpendicular to one or more of the plurality of drawing surfaces.

6. The information processing apparatus according to claim 4,
wherein the plurality of drawing surfaces are placed in a plurality of directions, each of the plurality of directions being substantially perpendicular to one or more of the plurality of drawing surfaces.

7. The information processing apparatus according to claim 1,
wherein the plurality of drawing surfaces surround a predetermined three-dimensional object.

8. The information processing apparatus according to claim 2,
wherein the plurality of drawing surfaces surround a predetermined three-dimensional object.

9. The information processing apparatus according to claim 1,
wherein the plurality of drawing surfaces enter a predetermine three-dimensional object.

10. The information processing apparatus according to claim 2,
wherein the plurality of drawing surfaces enter a predetermine three-dimensional object.

11. The information processing apparatus according to claim 1,
wherein the plurality of drawing surfaces are curved.

12. The information processing apparatus according to claim 11,
wherein the plurality of drawing surfaces that are curved are spherically shaped and surround a user.

13. The information processing apparatus according to claim 1,
wherein the processor is configured to:
display information recorded on the drawing surface selected as a target for drawing from the plurality of drawing surfaces differently from information recorded on any of the plurality of drawing surfaces other than the drawing surface selected as a target for drawing.

14. The information processing apparatus according to claim 1,
wherein the processor is configured to:
select another drawing surface as a target for drawing from the plurality of drawing surfaces by an operation performed on a button displayed in the generated space, an operation performed on a mechanical switch, or a movement in real space.

15. The information processing apparatus according to claim 1,
wherein the processor is configured to:
hide or delete one of the plurality of drawing surfaces in response to a predetermined operation.

16. The information processing apparatus according to claim 1,
wherein the processor is configured to:
add a drawing surface in response to a predetermined adding operation to add a drawing surface.

17. The information processing apparatus according to claim 16,
wherein the processor is configured to:
display the surface indicator on the added drawing surface as a target for drawing.

18. The information processing apparatus according to claim 1,
wherein the processor is configured to:
change an interval between the plurality of drawing surfaces in response to a predetermined adjusting operation to adjust the interval between the plurality of drawing surfaces.

19. A non-transitory computer readable medium storing a program causing a computer to execute a process for information processing, the process comprising:
generating a virtual reality space, an augmented reality space, or a mixed reality space;
placing a plurality of drawing surfaces in the generated space; and
displaying a surface indicator to make a drawing surface recognizable without obscuring information recorded on another drawing surface, the drawing surface being selected as a target for drawing from the plurality of drawing surfaces.

20. An information processing method comprising:
generating a virtual reality space, an augmented reality space, or a mixed reality space;
placing a plurality of drawing surfaces in the generated space; and
displaying a surface indicator to make a drawing surface recognizable without obscuring information recorded on another drawing surface, the drawing surface being selected as a target for drawing from the plurality of drawing surfaces.
